(19) United States
(12) Patent Application Publication
(10) Pub. No.: US 2019/0071573 A1
(43) Pub. Date: Mar. 7, 2019

(54) USE OF RED IRON OXIDE PIGMENTS IN AQUEOUS PREPARATIONS

(71) Applicant: LANXESS Deutschland GmbH, Cologne (DE)

(72) Inventors: Stephan SPIEGELHAUER, Langenfeld (DE); Carsten ROSENHAHN, Kempen (DE); Waldemar CZAPLIK, Viersen (DE); Juergen KISCHKEWITZ, Ratingen (DE)

(73) Assignee: LANXESS Deutschland GmbH, Cologne (DE)

(21) Appl. No.: 16/085,080

(22) PCT Filed: Mar. 15, 2017
(86) PCT No.: PCT/EP2017/056107

§ 371 Date: Sep. 14, 2018

(30) Foreign Application Priority Data
Mar. 16, 2016 (EP) 16160645.4

(51) Int. Cl. C09C 1/00; C09C 1/24; C09D 17/00

(52) U.S. Cl. CPC C09C 1/0084; C09C 1/24; C09D 17/001; C09D 17/008; C01P 2006/63; C01P 2006/12; C01P 2006/20; C01P 2006/22; C01P 2004/62

(57) ABSTRACT

The present invention relates to the use of a haematite pigment whose sum of the a* values in full shade and with reduction in the surface coating test is from 58.0 to 61.0 CIELAB units, preferably from 58.0 to 60.0 CIELAB units, more preferably from 58.5 to 61.0 CIELAB units, more preferably from 58.5 to 60.0 CIELAB units, particularly preferably from 59.0 to 61.0 CIELAB units, more particularly preferably from 59.0 to 60.0 for producing an aqueous, titanium dioxide-containing preparation.

The present invention relates to the use of specific iron oxide red pigments for producing (colouring) aqueous titanium dioxide-containing preparations, corresponding preparations and a process for the production thereof.

Iron oxides are employed in many industrial fields. Thus, for example, they are used as colour pigments in ceramics, building materials, plastics, paints, surface coatings and paper, serve as bases for various catalysts or support materials and can adsorb or absorb pollutants. Magnetic iron oxides are employed in magnetic recording media, toners, ferrofluids or in medical applications, for example as contrast agent for magnetic resonance tomography.

Iron oxides can be obtained by precipitation, hydrolysis and decomposition reactions of iron salts. The Laux, Copperas, precipitation, calcination and Penniman red processes have by far the greatest industrial importance.

The aqueous production of finely divided haematite, which corresponds to the modification α-Fe₂O₃, is, however, considerably more complicated. Use of a ripening step with addition of a finely divided iron oxide of the maghemite modification, γ-Fe₂O₃, or lepidocrocite, γ-FeOOH, as nucleus enables haematite also to be produced by direct aqueous precipitation [U.S. Pat. No. 5,421,878; EP0645437A; WO 2009/100767A].

A further method of producing iron oxide red pigments is the Penniman red process, also referred to as nitrate process or direct red process (U.S. Pat. Nos. 1,327,061; 1,368,748; 2,937,927; EP 1106577A: U.S. Pat. No. 6,503,315). Here, iron oxide pigments are produced by iron metal being dissolved and oxidized with addition of an iron salt and an iron oxide nucleus. Thus, SHEN, Qing; SUN, Fengzhi; Wujiyan Gongye 1997, (6), 5-6 (CH), Wujiyan Gongye Bianjib, (CA 128:218378n) have disclosed a process in which dilute nitric acid acts on iron at elevated temperature. This forms a haematite nucleus suspension. This is built up in a manner known per se to give a suspension of red pigment and the pigment is, if desired, isolated from this suspension in a conventional manner. However, the red pigments produced by this process have a comparatively low colour saturation which is similar to the colour saturation of a commercial 130 standard and are therefore primarily used in the building materials industry. The 130 standard corresponds to the reference standard Bayferrox® 130 (product of LANXESS Deutschland GmbH, Germany) customarily used for iron oxide pigment colour measurements.

EP 1106577A discloses a variant of the Penniman red process which comprises dilute nitric acid acting on iron at elevated temperature to produce nuclei, i.e. finely divided iron oxides having a particle size of less than or equal to 100 nm. The reaction of iron with nitric acid is a complex reaction and can lead either to passivation of the iron and thus cessation of the reaction or to dissolution of the iron to form dissolved iron nitrate, depending on the experimental conditions. Both reaction paths are undesirable and the production of finely divided haematite is successful only under limited experimental conditions. EP 1106577A describes such conditions for producing finely divided haematite. Here, iron is reacted with dilute nitric acid at temperatures in the range from 90 to 99° C.

WO 2013/045608 describes a process for producing iron oxide red pigments, in which the reaction step of production of the nuclei, i.e. of finely divided haematite having a particle size of less than or equal to 100 nm, has been improved.

In the nitrate process according to the prior art, iron or a mixture of iron and water is usually initially charged. The haematite nucleus suspension is then usually added to at least iron, and subsequently iron(II) nitrate solution is added to the mixture. The reaction usually commences after the temperature of the reaction mixture has been increased to from 70 to 99° C. and after introduction of an oxygen-containing gas has been started.

In all applications for colouring surface coatings, emulsion paints, coatings, plastics, building materials, paper, in foodstuffs and in products of the pharmaceutical industry, iron oxide red pigments whose red component a* (measured in admixture with white pigments, referred to as reduction, in accordance with CIELAB) is particularly pronounced are sought.

The higher the red component a* determined for colouring, the purer the colour of the red colour shade of the coloured medium (for example surface coating, plastic, coatings, building material, paper) appears.

Thus, it is demanded in the emulsion paints industry that the incorporation of the iron oxide red pigments into an emulsion paint system always leads to the same colour shade which is virtually independent of the duration of incorporation. The incorporation of the iron oxide red pigment into an emulsion paint system is carried out in industrial plants, e.g. bead mills, with mechanical forces being exerted on the pigment and this milling being able to take hours. A high degree of colour or quality constancy is ensured when the colour imparted by the iron oxide red pigment alters only very slightly in the case of fluctuations in the incorporation time. The lower the colour shade change on lengthening the incorporation time, the more milling stable is the iron oxide red pigment said to be. One measure of the colour constancy is the total colour difference ΔEab*, which is obtained when the colour shade of two emulsion paint triturations which have been obtained from the same emulsion paint and pigment raw materials in the same industrial plant at different incorporation times are compared. It is demanded here that the resulting total colour difference ΔEab* be as low as possible.

The total colour difference ΔEab* is determined in accordance with CIELAB using a method based on DIN EN ISO 11664-4:2011-07 and DIN EN ISO 787-25:2007 from the lightness L*, the red value * and the yellow value b* according to the following formula:

ΔEab*=[(ΔL*)²+(Δa*)²+(Δb*)²]^{1/2}

It was therefore an object of the present invention to provide iron oxide red pigments of which, in the colouring of media such as concrete, plastics, paints and varnishes, smaller amounts are required than of pigments according to the prior art in order to attain the same red shade, or by means of which a more intense colour shade is achieved when, in the colouring process, the same amount is used as of a pigment according to the prior an, with this property being present both in the case of intensive colouring of the medium and also in the case of weaker colouring by dilution with lighter pigments such as white pigments and the pigments additionally having a high milling stability.

For measuring the colour intensity of iron oxide red pigments, there are long-established test methods in which the colour of media such as concrete test specimens or surface coating system coloured with the iron oxide red pigments are measured. The parameters of the CIELAB colour space have become established as standard parameters for measuring the colour of iron oxide red pigments in the surface coating system. The fundamentals of these are set down in the standard DIN EN ISO 11664-4 “Colorimetry—Part 4: CIE 1976 L*a*b* colour space” (Beuth-Verlag, 2011-07 edition). Every perceptible colour in this three-dimensional colour space is defined by the colour location having the coordinates L* (lightness), a* (red-green value) and b* (yellow-blue value). When the countercolour theory is applied, green and red are here on the a* axis and the colours yellow-blue are opposite one another on the b* axis. The more positive an a* value, the more strongly is the colour red pronounced. On the other hand, the colour green is more strongly pronounced, the more negative the a* value. On the b* axis located perpendicular to the a* axis, this applies analogously to the countercolours yellow-blue. The more positive a b* value, the more strongly pronounced is the colour yellow. The colour blue is, on the other hand, more strongly pronounced, the more negative the b* value. The L* axis is perpendicular to the plane formed by the coordinates a* and b* and indicates the lightness. The L* axis is also referred to as neutral grey axis. It encompasses the end points black (L=0) and white (L=100). Apart from these parameters, the colour saturation C* (also known as chroma, chromaticity or colourfulness) is also often indicated. This value is derived directly from the values a* and b* and is the square route of the sum of the squares of a* and b*. a*, b*, L* and C* are dimensionless values. However, the dimension CIELAB units is customarily used in this context.

In the colour measurement of iron oxide red pigments, measurement in a test in a long oil alkyd resin which has been made thixotropic (using a method based on DIN EN ISO 11664-4:2011-07 and DIN EN ISO 787-25:2007, with, in a modification thereof, a long oil alkyd resin having an oil content of 64% by weight instead of 63% by weight and a different thixotrope being used. Details are given in the section Examples and Methods) has been found to be particularly informative. This test is, according to the invention, referred to as surface coating test. The alkyd resin has the advantage that it does not dry. As a result, measurements can be carried out more quickly than when the paste firstly has to be dried before the measurement. Further details of this test method are given in the section Examples and Methods. This test is also used for specification of industrially produced red pigments, for example those of LANXESS Deutschland GmbH. Here, not only the absolute values a*, b* and L* but also difference values Δa*, Δb* and ΔL* are reported, as is customary in the pigments industry. These difference values are determined by comparison of the values for the sample to be measured with a reference standard and represent the difference of value (sample) minus value (reference). The reference standards themselves are compared again among one another and bear unambiguous batch numbers, so that a direct comparison between samples and reference standards of different generations is always possible in addition to the comparison of the absolute values a*, b* and L*, even when the original reference sample is no longer available. A further parameter for the comparative measurement is the colour difference ΔE*. This is determined from the difference values Δa*, Δb* and ΔL* and is the square route of the sum of the squares of Δa*, Δb* and ΔL*.

There are two variants for carrying out the surface coating test, namely measurement in full shade and with reduction. In the full shade measurement, the pigment is dispersed in a clear paste under standard conditions defined in the standard. The colour values of the pigmented colour paste are then determined. In the measurement with reduction, titanium dioxide in the rutile modification is added to the paste, so that a ratio of pigment to titanium dioxide of 1:5 is obtained. As a result of the reduction, the colour intensity and colour purity of a pigment in the presence of a white pigment which lightens the colour can be evaluated.

Particularly colour-pure iron oxide red pigments having an a* value in full shade of from 29 to 30.5 CIELAB units for the surface coatings industry can be produced by the Copperas, precipitation and Penniman red process. These are distinguished by the particular red and yellow cast in full shade in the surface coating test and the colour saturation C* is up to 40.0 CIELAB units. With reduction, i.e. in the above-described mixture with titanium dioxide, however, they display a significant decrease in the red cast, i.e. lower a* values. However, it would be particularly advantageous from the point of view of use to have available iron oxide red pigments which have a very high red cast both in full shade and with reduction as a mixture with titanium dioxide. The sum of the a* values from full shade and with reduction is therefore defined as particularly suitable parameter for describing the behaviour of the red cast in full shade and with reduction. If various commercially available products are compared in respect of this parameter, it is found that the sum of a*(full shade) and a*(with reduction) is significantly below 58.0 CIELAB units.

The colour values in the surface coating test in full shade and with reduction of various commercially available pigments are shown in Table 1 below.

TABLE 1
Colour values of iron oxide red pigments according to the prior art

| | | | | | | | Sum of a* |
|---|---|---|---|---|---|---|---|
| | a* full | b* full | C* full | a* with | b* with | C* with | in full shade + |
| Iron oxide | shade | shade | shade | reduction | reduction | reduction | a* with reduction |
| R1599D ¹⁾ | 30.5 | 24.8 | 39.3 | 27.2 | 18.8 | 33.1 | 57.7 |
| R1299D ¹⁾ | 30.3 | 24.9 | 39.2 | 27.4 | 20.1 | 34.0 | 57.7 |
| SILO208 ²⁾ | 29.7 | 23.8 | 38.0 | 26.1 | 17.4 | 31.4 | 55.8 |
| Bayferrox ® 105 ³⁾ | 29.5 | 24.5 | 38.4 | 25.9 | 18.1 | 31.6 | 55.4 |
| Bayferrox ®110 ³⁾ | 28.4 | 23.0 | 36.6 | 25.6 | 17.8 | 31.2 | 54.0 |
| Penniman Red 808 ⁴⁾ | 29.3 | 25.2 | 38.7 | 28.2 | 24.7 | 37.5 | 57.5 |
| Penniman Red NS110 ⁴⁾ | 29.7 | 24.5 | 38.5 | 27.2 | 21.2 | 34.4 | 56.9 |
| Pigment analogous | 30.0 | 25.2 | 39.2 | 27.1 | 20.2 | 33.8 | 57.1 |
| to Examples 3 and 4 | | | | | | | |
| of DE4235947A ⁵⁾ | | | | | | | |
| Pigment analogous | 28.8 | 26.4 | 39.1 | 27.8 | 25.7 | 37.9 | 56.6 |
| to Examples 3 and 4 | | | | | | | |
| of DE4235947A ⁵⁾ | | | | | | | |

¹⁾ Copperas ® pigment from Rockwood Pigments NA, Inc., produced by the Copperas ® process
²⁾ Ferroxide ™ pigment from Rockwood Pigments NA, Inc., produced by the precipitation process
³⁾ Pigments from LANXESS Deutschland GmbH, produced by the Laux process via a calcination step.
⁴⁾ Pigments from Yixing Yuxing Industry and Trading Company, produced by the Penniman red process,
⁵⁾ Pigments produced by the precipitation process. The examples were produced in a manner analogous to Examples 3 and 4 of DE 4235947A and the colour values thereof were measured in the surface coating test in full shade and with reduction.
The invention provides the use of a haematite pigment whose sum of the a* values in full shade and with reduction in the surface coating test is from 58.0 to 61.0 CIELAB units, preferably from 58.0 to 60.0 CIELAB units, more preferably from 58.5 to 61.0 CIELAB units, more preferably from 58.5 to 60.0 CIELAB units, particularly preferably from 59.0 to 61.0 CIELAB units, more particularly preferably from 59.0 to 60.0, for the production of an aqueous, titanium dioxide-containing preparation.

A) Haematite Pigment

In a preferred embodiment, the titanium dioxide-containing preparation comprises the pigments according to the invention whose sum of the a* values in full shade and with reduction in the surface coating test is from 58.0 to 61.0 CIELAB units, preferably from 58.0 to 60.0 CIELAB units, more preferably from 58.5 to 61.0 CIELAB units, more preferably from 58.5 to 60.0 CIELAB units, particularly preferably from 59.0 to 61.0 CIELAB units, more particularly preferably from 59.0 to 60.0 CIELAB units, and also an organic coating, preferably with oils, waxes, fatty acids or fatty acid salts, and/or an inorganic coating, preferably with inorganic salts such as carbonates, oxides or hydroxides of alkali metals and alkaline earth metals or of Mg, Zn, Al, La, Y, Zr, Sn and/or Ca, or in each case not.

The preferred haematite pigments have the modification α-Fe₂O₃. In a further preferred embodiment, they have a particle size of from 0.1 to 0.3 μm. Particular preference is given to at least 80% by weight of the preferred haematite pigments having a particle size of from 0.1 to 0.3 μm.

The haematite pigments also preferably have an oil number of from 15 to 26, preferably from 15 to 24, measured in accordance with DIN EN ISO 787-5: 1995.

The haematite pigments likewise preferably have a water content of 1.0% by weight or more, preferably from 1.0 to 5.0% by weight. The water is particularly preferably present as water of crystallization.

The haematite pigments also preferably have a chloride content of from 0.001 to 0.1% by weight of chloride. For the purposes of the invention, the chloride content is the total content of chloride in the haematite pigment.

Particular preference is given to haematite pigments which have the modification α-Fe₂O₃, have a particle size of from 0.1 to 0.3 μm, very particularly preferably at least 80% by weight of the haematite pigments have a particle size of from 0.1 to 0.3 μm, and have an oil number of from 17 to 26, preferably from 19 to 24, measured in accordance with DIN EN ISO 787-5: 1995, and preferably have a water content of 1.0% by weight or more, preferably from 1.0 to 5.0% by weight.

Production of the Haematite Pigments

The haematite pigments are preferably produced by reaction of iron with an aqueous haematite nucleus suspension and an iron(II) salt solution, preferably iron(II) nitrate solution, in the presence of at least one oxygen-containing gas, known as the Penniman red process. In a further preferred embodiment, the haematite pigments are produced by a process which excludes a calcination step at temperatures of greater than 600° C.

In a further embodiment, the production process comprises at least the reaction of iron, haematite nucleus suspension containing haematite nuclei which have a particle size of 100 nm or less and a specific BET surface area of from 40 m²/g to 150 m²/g (measured in accordance with DIN 66131) and iron(II) nitrate solution in the presence of at least one oxygen-containing gas at temperatures of from 70 to 99° C., characterized in that the reaction takes places during introduction of an oxygen-containing gas in a pH range of from pH 2.2 to pH 4.0, preferably from pH 2.2 to pH 3.0, with a haematite pigment suspension being produced.

In a preferred embodiment, the reaction takes place at least in the first 40 hours during the introduction of an oxygen-containing gas, preferably for more than 80% of the first 40 hours during the introduction of the gas, in a pH range from pH 2.2 to pH 4.0, preferably from pH 2.2 to pH 3.0.

Surprisingly, the regulation of the pH of the reaction suspension is successively achieved by not only the oxygen-containing gas but in addition gaseous nitrogen being introduced into the reaction mixture, preferably into the liquid phase. This can occur either during the entire reaction time, for example with different volumes/hour of reaction time, or preferably only when the pH of the reaction mixture drops below 2.2. The gaseous nitrogen preferably contains from 0 to 10% by volume of oxygen, preferably from 0 to 1% by volume of oxygen. The oxygen-containing gas likewise preferably contains from 15 to 100% by volume of oxygen. Preference is given to introducing gaseous nitrogen into the reaction mixture in such an amount that the oxygen content based on the total volume of oxygen-containing gas and gaseous nitrogen is from 0 to 15% by volume, preferably from 0 to 10% by volume. Here, the introduction of the gaseous nitrogen can be carried out in such a way that the introduction of the oxygen-containing gas is either continued or interrupted, but the sum of the gas introduction volumes of oxygen-containing gas and gaseous nitrogen is at least 1 m³ of gas volume/m³ of batch volume/hour. As a result of the introduction of gaseous nitrogen into the reaction mixture, the pH of the reaction mixture increases so quickly that the pH of the reaction mixture can be kept below the limit of pH 2.2-pH 4.0, preferably pH 2.2-pH 3.0. The introduction of nitrogen is, according to the invention, stopped again after attainment of the upper pH limit of more than pH 4.0, preferably more than pH 3.0, and only recommenced after attainment of the lower pH limit of less than pH 2.2. A pH profile of such a process is shown in FIG. 1. The reaction time is shown on the x axis and the pH of the reaction mixture is shown on the y axis.

A reduction in the gas introduction volume of the oxygen-containing gas below 0.2 m³ of gas volume/m³ of batch volume/hour without additional introduction of gaseous nitrogen, on the other hand, only briefly leads to an increase in the pH but subsequently leads within less than one hour to a great decrease in the pH to pH 1.7 or less because of passivation of the iron present in the reaction mixture. Passivation of the iron takes place by formation of closed iron hydroxide and iron oxide deposits on the iron surface. The iron is thus completely wetted on the surface by a closed iron oxide/iron hydroxide layer. This leads to undesirable premature cessation and thus to an incomplete reaction.

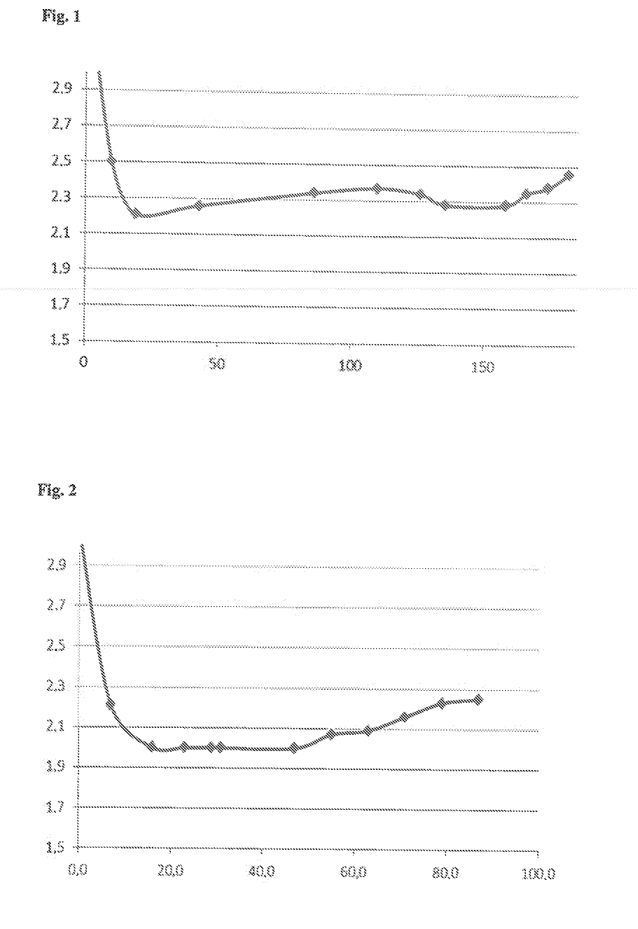

The pH profile of a typical reaction according to the Penniman red process as per the prior art is shown in FIG. 2.

The reaction time is shown on the x axis and the pH of the reaction mixture is shown on the y axis. The pH of the reaction mixture is usually 2.5 or more and is defined by the mixing of the acidic iron(II) nitrate solution and the acidic haematite nucleus suspension. After commencement of the introduction of gas at elevated temperatures, typically from 70 to 99° C., the pH drops within about 20 hours to below 2.1 and then rises again over a further 40 hours to a pH of from 2.1 to 2.3. In reactions which display such a pH profile, haematite pigments which have a sum of the a* values in full shade and with reduction of 57.5 and less are obtained.

In one embodiment, the reaction is carried out until the haematite pigment has the desired colour shade in the surface coating test, i.e. has the appropriate a* values in full shade and with reduction. The a* values usually increase during the reaction in the presence of at least one oxygen-containing gas at temperatures of from 70 to 99° C. For this reason, samples are taken at various times during the reaction and examined in the surface coating test. An examination in the surface coating test can usually be carried out within one hour. Within this time, the colour values of the haematite in the reaction mixture can undergo a further slight change. In industrial production according to the preferred process, which on the basis of experience proceeds very reproducibly, a person skilled in the art will, however, be able to determine the optimal time for stopping the reaction.

In a further embodiment, the preferred process comprises separation of the haematite pigment from the haematite pigment suspension by customary methods.

The reaction of iron, haematite nucleus suspension and iron(II) nitrate solution in the presence of at least one oxygen-containing gas at temperatures of from 70 to 99° C. is also referred to as pigment buildup.

The haematite pigments produced have the modification haematite (α-Fe₂O₃) and are therefore referred to as haematite pigments in connection with the present invention.

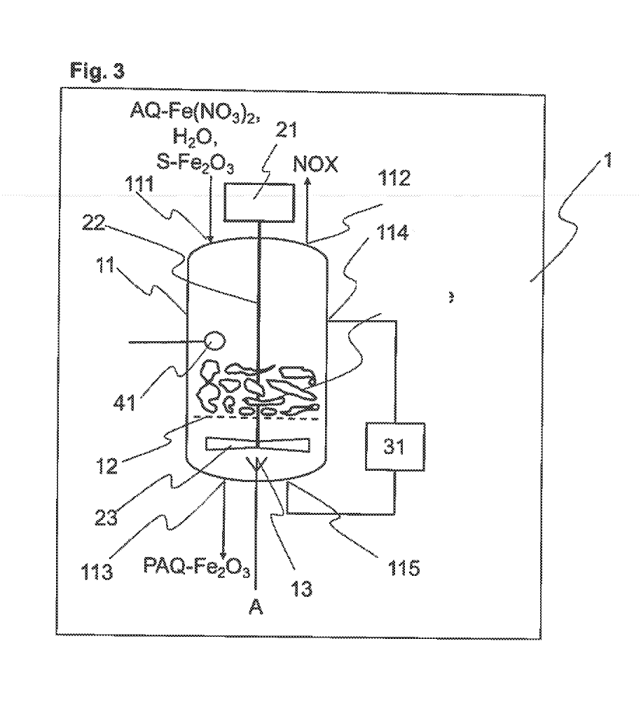

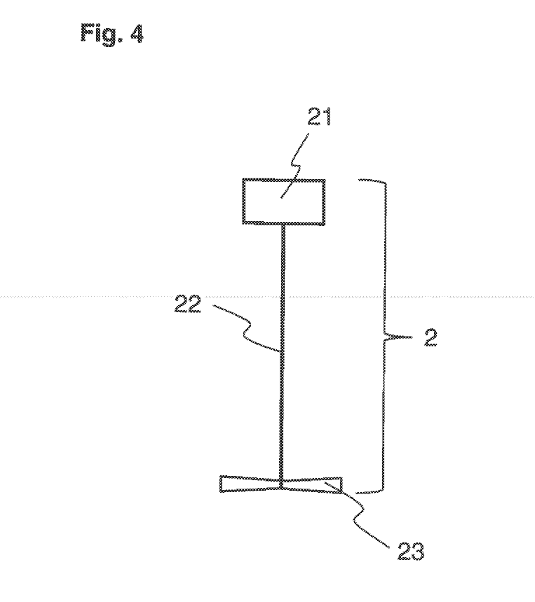

The pigment buildup in such a process is, in one embodiment, carried out in a reactor as shown in FIG. 3.

The further apparatuses suitable for carrying out the production process are described in more detail below with the aid of FIG. 3.

FIG. 3 shows a depiction of an apparatus which is preferably used.

In FIG. 3, the abbreviations and symbols have the following meanings:
A oxygen-containing gas
Fe iron
AQ-Fe(NO₃)₂ iron(I) nitrate solution
S—Fe₂O₃ haematite nucleus suspension
PAQ-Fe₂O₃ haematite pigment suspension
H₂O water
NOX nitrogen oxide-containing stream (offgas from the production of the haematite pigment suspension)
1 reactor for producing haematite pigment suspension
11 reaction vessel
12 support for iron
13 gas introduction unit
111 inlet for iron(II) nitrate solution, haematite nucleus suspension
112 outlet for NOX
113 outlet for haematite pigment suspension
114 outlet for liquid phase
115 inlet for liquid phase
2 stirring device
21 drive
22 connection between drive and stirrer
23 stirrer
31 pump
41 pH electrode

Reactor 1 typically comprises one or more reaction vessels made of materials which are resistant to the starting materials. Simple reaction vessels can be, for example, brick-lined or tiled vessels let into the earth. The reactors also encompass, for example, vessels made of glass, nitric acid-resistant polymers, e.g. polytetrafluoroethylene (PTFE), steel, e.g. enamelled steel, polymer-coated steel or painted/varnished steel, stainless steel having the material number 1.44.01. The reaction vessels can be open or closed. In preferred embodiments, the reaction vessels are closed. The reaction vessels are typically designed for temperatures in the range from 0 to 150° C. and for pressures of from 0.05 MPa to 1.5 MPa.

A preferred embodiment of a reactor 1 is shown in FIG. 1. Reactor 1 comprises at least reaction vessel 11, support 12 for iron, gas introduction unit 13 for the at least one oxygen-containing gas A, inlet 111 for at least iron(II) nitrate solution and haematite nucleus suspension, outlet 112 for a nitrogen oxide-containing stream NOX, outlet 113 for the haematite pigment suspension, outlet for liquid phase 114, inlet for liquid phase 115, a stirring device 2 comprising a drive 21, a connection between drive and stirrer 22, a stirrer 23, a pump 31 and a pH electrode 41. Outlet 114, inlet 115 and pump 31 are connected to one another via a conduit in such a way that the liquid phase can be circulated through this from the reaction vessel 11 and back into the reaction vessel 11.

A further preferred embodiment of a reactor 1 comprises at least reaction vessel 11, support 12 for iron, gas introduction unit 13 for the at least one oxygen-containing gas A, inlet 111 for at least iron(II) nitrate solution and haematite nucleus suspension, outlet 112 for a nitrogen oxide-containing stream NOX, and outlet 113 for the haematite pigment suspension and optionally a pH electrode 41.

A further preferred embodiment of a reactor 1 comprises at least reaction vessel 11, support 12 for iron, gas introduction unit 13 for the at least one oxygen-containing gas A, inlet 111 for at least iron(II) nitrate solution and haematite nucleus suspension, outlet 112 for a nitrogen oxide-containing stream NOX, outlet 113 for the haematite pigment suspension, a stirring device 2 comprising a drive 21, a connection between drive and stirrer 22, a stirrer 23 and optionally a pH electrode 41.

A further preferred embodiment of a reactor 1 comprises at least reaction vessel 11, support 12 for iron, gas introduction unit 13 for the at least one oxygen-containing gas A, inlet 111 for at least iron(II) nitrate solution and haematite nucleus suspension, outlet 112 for a nitrogen oxide-containing stream NOX, outlet 113 for the haematite pigment suspension, outlet for liquid phase 114, inlet for liquid phase 115, a pump 31 and optionally a pH electrode 41.

The preferred production process will be described in more detail below.

The figures describe:

FIG. 1: pH profile of a reaction in the preferred process. The time (h) is plotted on the x axis, and the pH value of the reaction mixture is plotted on the y axis.

FIG. 2: pH profile of a nitrate process according to the prior art. The time (h) is plotted on the x axis, and the pH value of the reaction mixture is plotted on the y axis.

FIG. 3: reactor 1 for carrying out the preferred process

FIG. 4: stirring device 2

It may be remarked at this point that the scope of the invention encompasses all desired and possible combinations of the general ranges or components, value ranges or process parameters indicated in preferred ranges as described above and in the following.

The aqueous haematite nucleus suspensions used in the preferred process and the haematite nuclei present therein are known from the prior art. On this object, reference may be made to the description of the prior art. The haematite nuclei present in the water-containing haematite nucleus suspension comprise nuclei having a particle size of 100 nm or less and a specific BET surface area of from 40 m²/g to 150 m²/g (measured in accordance with DIN 66131). The criterion of the particle size is satisfied when at least 90% of the haematite nuclei have a particle size of from 100 nm or less, particularly preferably from 30 nm to 90 nm. The aqueous haematite nucleus suspensions used in the preferred process typically comprise haematite nuclei having a round, oval or hexagonal particle shape. The finely divided haematite typically has a high purity. As foreign metals, manganese, chromium, aluminium, copper, nickel, cobalt, and/or titanium are generally present in wide-ranging concentrations in the iron scrap used for producing the haematite nucleus suspension and these can also be precipitated as oxides or oxyhydroxides in the reaction with nitric acid and be incorporated into the finely divided haematite. The haematite nuclei present in the water-containing haematite nucleus suspension typically have a manganese content of from 0.1 to 0.7% by weight, preferably from 0.4 to 0.6% by weight. Intensely coloured red iron oxide pigments can be produced using nuclei of this quality.

The iron(II) nitrate solutions used in the preferred process are known from the prior art. On this subject, reference is made to the description of the prior art. These iron(II) nitrate solutions typically have concentrations of from 50 to 150 g/l of Fe(NO₃)₂ (figures for Fe(NO₃)₂ based on anhydrous substance). Apart from Fe(NO₃)₂, the iron(II) nitrate solutions can also contain amounts of from 0 to 50 g/l of Fe(NO₃)₃. However, very small amounts of Fe(NO₃)₃ are advantageous.

Iron in the form of wire, sheets, nails, granules or coarse turnings is usually used as iron in the preferred process. Here, the individual pieces are of any shape and usually have a thickness (e.g. measured as diameter of a wire or as thickness of a sheet) of from about 0.1 millimetre to about 10 mm. The size of wire bundles or of sheets which are used in the process is usually determined by practical points of view. Thus, the reactor has to be able to be filled without difficulty with this starting material, which generally occurs through a manhole. Such iron is produced, inter alia, as scrap or as by-product in the metal processing industry, for example stamping sheets.

The iron used in the preferred process generally has an iron content of >90% by weight. As impurities, foreign metals such as manganese, chromium, silicon, nickel, copper, and other elements usually occur in this iron. However, iron having a higher purity can also be used without disadvantages. Iron is typically used in an amount of from 20 to 150 g/l, based on the volume of the reaction mixture at the beginning of the preferred reaction. In a further preferred embodiment, the iron, preferably in the form of stamping sheets or wires, is distributed on the iron support over the area of the latter in a preferred bulk density of less than 2000 kg/m³, particularly preferably less than 1000 kg/m³. The bulk density can, for example, be realized by bending of sheets of at least one iron grade and/or by targeted laying of the iron. This leads to typically more than 90 percent by volume of the oxygen-containing gas blown in under the iron support passing through the iron support without the oxygen-containing gas banking up under the iron support.

The support for iron, for example support 12, allows exchange of suspension and gas through openings present in the support for iron. Typical embodiments of the support for iron can be sieve trays, perforated plates or meshes. In one embodiment, the ratio of the cumulated area of openings to the total area of the support is from 0.1 to 0.9, preferably from 0.1 to 0.3. The holes or openings required for exchange of the suspension are typically selected so that the iron is as far as possible prevented from falling through the support for iron. The support for iron, for example support 12, can have a diameter corresponding to the internal diameter of the reactor, for example the internal diameter of the reaction vessel 11, or can be made smaller. In the latter case, a wall is preferably installed at the side of the support device for iron so as to prevent iron from falling down. This wall can be suspension-permeable, for example when configured as mesh, or be suspension-impermeable and, for example, correspond to the shape of a tube or a cuboid open at the top.

The total amount of iron is preferably initially charged in an amount of from 100 to 140% by weight, preferably from 100 to 120% by weight, of the amount of iron reacted in the reaction for carrying out the process. The amount of iron reacted in the reaction is determined by difference weighing of the amount of iron before and after the reaction.

In a variant according to the prior art, a particular amount of iron is initially charged and further iron is then added in portions during the entire reaction time, with a significant overall excess, typically from 150 to 200% by weight of the amount of iron reacted in the reaction, being used. Although the pH of the reaction mixture can be increased in this way, an improvement in the colour properties of the resulting pigments cannot be achieved.

In a preferred embodiment, low-salt water is used as water in the process for producing the haematite nucleus suspension and/or the iron(II) nitrate solution and/or the haematite pigment suspension. The conductivity can be considered to be a simplified measure of the salt burden. Low-salt water for the purposes of the invention has a conductivity of 20 μS/cm or less, preferably 10 μS/cm or less, particularly preferably 5 μS/cm or less. Polyvalent anions such as phosphate, silicate, sulfate and carbonate, which are frequently present in process water, can have a flocculating effect on the iron oxide pigments and lead to the iron oxide pigment flocculating during the reaction and settling as sediment on the bottom of the reactor. To avoid this effect, preference is given to using low-salt water, e.g. deionized water (DI water), distilled water or water from reverse osmosis. Furthermore, the colour values of the haematite pigments are improved thereby. In a particularly preferred embodiment, low-salt water is used as water in the process for producing the haematite nucleus suspension and the iron(II) nitrate solution and the haematite pigment suspension. The colour values of the pigments are again improved thereby.

In the preferred process, the reaction of at least iron, haematite nucleus suspension and iron(II) nitrate solution occurs in the presence of at least one oxygen-containing gas at temperatures of from 70 to 99° C.

The at least one oxygen-containing gas is preferably selected from among air, oxygen, air heated to above ambient temperature or air enriched with water vapour.

According to the preferred process, the reaction of at least iron, haematite nucleus suspension and iron(II) nitrate solution occurs in such a way that at least the liquid phase present during the reaction is mixed by means of mechanical and/or hydraulic mixing, or else is not. Since suspended haematite is present in the liquid phase, the mechanical and/or hydraulic mixing is, if desired, preferably carried out in such a way that the haematite suspended in the liquid phase remains uniformly dispersed in the liquid phase and does not accumulate in the lower part of the liquid phase.

For the purposes of the present invention, mechanical mixing is mixing of the liquid phase by means of suitable devices. The liquid phase preferably also contains solids suspended therein, for example the haematite nuclei or the haematite pigment and also further solids such as iron particles. In the case of mechanical mixing, the suitable devices encompass stirring devices, for example axial stirrers, radial stirrers and tangential stirrers. Stirring devices such as the stirring device 2 in FIG. 1 have at least one stirrer such as the stirrer 23 in FIG. 1, for example propellers, helices or blades which generate flow of the liquid phase. Stirring devices typically also have a drive such as drive 21 in FIG. 1, e.g. a motor, and a connection between stirrer and drive 22, e.g. a shaft or magnetic coupling. Depending on the type of stirrer, flows are generated in the radial direction, i.e. at right angles to the axis of stirring, or in the axial direction, i.e. parallel to the axis of stirring, or mixtures thereof. For example, blade stirrers preferably generate radial flows, inclined-blade stirrers and propeller stirrers generate axial flows. Axial flows can be directed upwards or downwards. For the purposes of the present invention, mechanical mixing of the liquid phase which is directed axially from the bottom upwards through the iron is preferred. This ensures that the liquid phase present in the hollow spaces of the iron pieces is also mixed with the liquid phase which is present outside the hollow spaces of the iron pieces. The at least one stirrer is preferably located below and/or above the iron. Preference is likewise given to axial stirrers, particularly preferably inclined-blade stirrers or propeller stirrers, as stirrers.

In one embodiment, baffles are additionally present on the inside of the wall of the reaction vessel 1 in the case of radially acting stirrers. In this way, corotation of the liquid phase and the resulting formation of vortices is avoided.

The degree of mechanical mixing is defined by the outer circumferential velocity of the stirrer, for example the stirrer 23. Preferred circumferential velocities are 0.5-15 m/s, measured at the circumference of the circle formed by the diameter of the stirrer. The power input into the liquid phase, which can be deduced from the power uptake of the stirrer, is preferably from 0.1 to 5 kW per m³ of batch volume, preferably from 0.4 to 3 kW per m³ of batch volume. The ratio of stirrer diameter to internal diameter of the reactor is preferably from 0.1 to 0.9. The power input into the liquid phase is given by the power uptake of the stirrer multiplied by the efficiency of the stirrer in percent. Typical efficiencies of stirrers which are used in the preferred process are in the range from 70 to 90%. For the purposes of the invention, circumferential velocities of from 1 to 15 m/s and a power input of at least 0.4 kW/m³ of batch volume are particularly preferred.

In a further embodiment, hydraulic mixing occurs with the aid of a pump, for example pump 31, which takes in the liquid phase from the reactor at an outlet, for example outlet 114, and feeds it back into the reactor again at a different point at an inlet, for example inlet 115. Flows are in this way produced at the inlet and outlet and also in the entire reaction mixture. Hydraulic mixing is carried out with the aid of a pump, for example pump 31, which takes in the liquid phase from the reactor at an outlet, for example outlet 114, and feeds it back into the reactor again at a different point at an inlet, for example inlet 115. Flows are in this way produced at the inlet and outlet and also in the entire reaction mixture. For the purposes of the invention, preference is given to pumped amounts of from 0.1 to 20 batch volumes/hour. For example, the pumped amount at a batch volume of 30 m³ and a value of 5 batch volumes/hour is 150 m³/hour. In a further embodiment, preference is given to pumped amounts which generate a flow velocity at the inlet, for example inlet 115, of at least 0.05 m/s, preferably from at least 0.06 to 15 m/s. Here, the flow velocities are measured at the inlet directly at the transition of the conduit from which the pumped liquid phase flows into the reaction mixture in the interior of the reactor. In a further embodiment, the flow is directed from the inlet, for example inlet 115, onto the support for iron, for example support for iron 12, preferably directed from below the support for iron onto the support for iron at a distance of less than 2 m, preferably less than 1 m. In a further embodiment, the inlet, for example inlet 115, is configured as pipe or as two-fluid sprayer or as nozzle.

In a preferred embodiment of the preferred process, the reaction of at least iron, haematite nucleus suspension and iron(II) nitrate solution occurs with introduction of at least one oxygen-containing gas at a gas introduction volume of 6 m³ of gas volume/m³ of batch volume/hour or less, preferably from 0.2 to 6 m³ of gas volume/m³ of batch volume/hour, particularly preferably from 0.2 to 5 m³ of gas volume/m³ of batch volume/hour, very particularly preferably from 0.2 to 3 m³ of gas volume/m³ of batch volume/hour.

In a further embodiment, the introduction of at least one oxygen-containing gas occurs without mechanical mixing and without hydraulic mixing. Only the introduction of the oxygen-containing gas in this case leads to strong mixing of the reaction mixture, for example at gas introduction volumes of from 7 to 10 m³ per hour and m³ of batch volume, as a result of which strong convection and strong bubble formation, comparable to vigorous boiling of a liquid, at the surface of the reaction mixture is generated in the reaction mixture.

The reaction mixture preferably comprises all starting materials and the solid, liquid and gaseous products formed therefrom. During the reaction, a nitrogen oxide-containing stream NOX is also formed. In a preferred embodiment, the nitrogen oxide-containing stream NOX is discharged from the reactor, for example via the outlet 112 of reactor 1. The batch volume is preferably defined as the total volume of the liquid and solid constituents of the reaction mixture which is present at a particular point in time during the reaction in the reaction vessel, for example in reactor 1. The batch volume can, for example, be determined at any point in time during the reaction by means of a fill level indicator on the reactor in which the reaction is carried out.

The introduction of at least one oxygen-containing gas is preferably carried out by at least one oxygen-containing gas being introduced from below the support for iron, for example support 12, into liquid phase of the reaction mixture. Preference is given to using a gas introduction unit, for example gas introduction unit 13, for example sparging ring, nozzles, (two)-fluid sprayers or a ring conduit provided with holes, which is located within the reaction mixture for introduction of the gas. For this purpose, the at least one oxygen-containing gas has to have a sufficient pressure to overcome the hydrostatic pressure of the liquid column of the reaction mixture. Gaseous nitrogen is preferably introduced, for example via the gas introduction unit 13 or another device, into the reaction mixture when the pH of the reaction mixture drops below 2.2. The introduction of gaseous nitrogen into the reaction mixture is stopped when the pH is back in the range from pH 2.2 to pH 4.0, preferably from pH 2.2 to pH 3.0. The pH of the reaction mixture can be determined by regular sampling of the reaction mixture or by means of a pH measuring sensor, for example pH sensor 41, located within the reaction vessel. The pH sensor 41 is installed in such a way that it is located completely within the reaction mixture.

During the preferred process, the pigment is built up on the haematite nuclei present in the liquid phase, as a result of which a haematite pigment suspension whose colour values, preferably the a* and b* values in the surface coating test, change during the reaction as a result of the particle size and/or morphology which changes during pigment build up is produced. The point in time at which the preferred process is stopped is determined by measuring the colour values of the haematite pigment present in the haematite pigment suspension. The preferred process is stopped when the haematite pigment displays the required sum of the a* values in full shade and with reduction in the surface coating test of at least 58.0 CIELAB units, preferably more than 58.5 CIELAB units, particularly preferably more than 59.0 CIELAB units. A comprehensive description of the surface coating test carried out may be found in the section Examples and Methods. The reaction is stopped by ending the introduction of gas, optionally by simultaneous cooling of the reaction mixture to a temperature below 70° C. Typical reaction times for the preferred reaction are from 10 to 150 hours, depending on the desired colour shade.

In a preferred embodiment, the haematite pigment is separated off from the haematite suspension by customary methods, preferably by filtration and/or sedimentation and/or centrifugation, after the preferred reaction. Washing of the filter cake obtained after the separation and subsequent drying of the filter cake likewise preferably take place. Preference is likewise given to carrying out one or more sieving steps, particularly preferably using different mesh openings and decreasing mesh openings, before the haematite pigment is separated off from the haematite pigment suspension. This has the advantage that foreign bodies, for example metal pieces, which would otherwise contaminate the haematite pigment are separated from the haematite pigment suspension.

To separate off the haematite pigment from the haematite pigment suspension, it is possible to carry out all procedures known to a person skilled in the art, e.g. sedimentation with subsequent removal of the aqueous phase or filtration by means of filter presses, for example by means of membrane filter presses.

In a preferred embodiment of the preferred process, at least one sulfate salt, for example iron(II) sulfate and/or an alkali metal sulfate or alkaline earth metal sulfate, preferably iron(II) sulfate and/or sodium sulfate, can be added to the haematite pigment suspension during or before sieving and/or during or before the separation. This has the advantage that the sedimentation of the haematite pigment from the haematite pigment suspension is accelerated. This assists the subsequent isolation of the haematite pigment.

At least one washing of the sediment or filter cake which has been separated off in this way may subsequently be carried out. After the separation and/or the washing, drying of the haematite pigment which has been separated off in this way is optionally carried out, for example using filter dryers, belt dryers, kneading dryers, spin-flash dryers, drying ovens or spray dryers. Drying is preferably carried out using belt dryers, plate dryers, kneading dryers and/or spray dryers.

Haematite pigments which are particularly suitable for the use according to the invention for producing aqueous titanium dioxide-containing, milling-stable pigment preparations are surprisingly provided by means of the preferred process.

A) Titanium Dioxide

As preferred titanium dioxide, use is made of the rutile type, in particular a rutile having an average particle size of from 0.25 to 0.35 μm, preferably from 0.30 to 0.31 μm. A preferred titanium dioxide likewise has an oil adsorption of from 18 to 24 g/100 g measured in accordance with DIN EN ISO 787-5: 1995. The titanium dioxide also preferably has a surface coating containing aluminium oxide (Al₂O₃) and silicon oxide (SiO₂).

The titanium oxide is preferably used in an amount of from 5 to 20% by weight, in particular from 8 to 15% by weight, based on the aqueous preparation.

Furthermore, a weight ratio of haematite pigment to TiO₂ of from 1:0.5 to 1:20, in particular from 1:1 to 1:10, is preferred.

C) Further Additives

The aqueous pigment preparation to be produced preferably contains a binder, preferably binder dispersions of synthetic polymers or copolymers, with acrylic acid, acrylic esters, acrylic anhydride, acrylonitrile, methacrylic acid, maleic acid, maleic esters, maleic anhydride, styrene, olefins, vinyl chloride or vinyl acetate being most frequently used as monomers.

Furthermore, the aqueous pigment preparations can contain wetting agents and dispersants and water and also optionally auxiliaries customary for pigment preparations, for example additional solvents, humectants, preservatives, antifoams, pH regulators and rheological additives which serve as antisedimentation agents.

The wetting agents and dispersants for inorganic pigments have the task of wetting the pigments, dispersing pigments and stabilizing the pigment preparations.

According to the prior art, preference is given to using polymeric dispersants and anionic, cationic and nonionic surfactants in order to disperse the pigments in aqueous dispersions or modify the surface.

As polymeric dispersants, use is customarily made of low molecular weight polymers of acrylic acid or copolymers of acrylic acid, methacrylic acid and maleic acid, and sodium, potassium or ammonium salts thereof.

As anionic surfactants, use is made of amphiphilic compounds whose hydrophobic group is an aliphatic or aromatic radical and whose hydrophilic group contains a carboxylic, sulfonic or phosphonic acid group or is an ester of sulfuric acid or phosphoric acid.

Preferred nonionic surfactants which are used as dispersants for pigment preparations are fatty alcohol ethoxylates, alkylphenol ethoxylates and copolymers of ethylene oxide, propylene oxide and styrene oxide.

Suitable anionic dispersants are preferably anionic surfactants from the group consisting of the sodium, potassium and ammonium salts of fatty acids, alkylbenzenesulfonates, alkyl sulfonates, olefin sulfonate, polynaphthalenesulfonates, alkyl sulfates, alkyl polyethylene glycol ether sulfates, alkylphenol polyethylene glycol ether sulfates, sulfosuccinic esters, alkyl polyethylene glycol ether phosphates, alkyl polyethylene glycol ether carboxylic acids and salts thereof, monoesters of sulfuric acid and phosphoric esters of styrene-substituted phenol ethoxylates, styrene-substituted phenol polyethylene glycol ether carboxylic acids and salts thereof, sodium fatty acid isethionates, sodium fatty acid methyl taurides and sodium fatty acid sarcosides.

Suitable humectants and solvents are preferably glycol ethers, which for the present purposes are, in particular, compounds which have ethoxy and/or propoxy groups and have average molar masses in the range from 200 to 20 000 g/mol, in particular polyethylene glycol ethers or polypropylene glycol ethers having an average molar mass in the range from 200 to 20 000 g/mol, monoethylene glycol, diethylene glycol or triethylene glycol, monopropylene glycol, dipropylene glycol or tripropylene glycol, methyl, ethyl, propyl, butyl or higher alkyl polyalkylene glycol ethers having 1, 2, 3 or more ethylene glycol or propylene glycol units, for example methoxypropanol, dipropylene glycol monomethyl ether, tripropylene glycol monomethyl ether, ethylene glycol monobutyl ether, diethylene glycol monobutyl ether, butyl polyethylene glycol ether, propyl polyethylene glycol ether, ethyl polyethylene glycol ether, methyl polyethylene glycol ether, dimethyl polyethylene glycol ether, dimethyl polypropylene glycol ether, glycerol ethoxylates having a molecular weight of from 200 to 20 000 g/mol, pentaerythritol alkoxylates having a molecular weight of from 200 to 20 000 g/mol, or further ethoxylation and alkoxylution products and random or block copolymers which are produced by addition of ethylene oxide and/or propylene oxide onto monohydric and polyhydric alcohols and have a molecular weight of from 200 to 20 000 g/mol. Average molar mass/molecular weight is number average molar mass/molecular weight.

Further suitable auxiliaries for the aqueous pigment preparations according to the invention are preferably water-soluble organic or hydrotropic substances, which may also serve as solvents.

Particularly suitable compounds for this purpose are, for example, formamide, urea, tetramethylurea, s-caprolactam, glycerol, diglycerol, polyglycerol, N-methylpyrrolidone. 1,3-diethyl-2-imidazolidinone, thiodiglycol, sodium benzenesulfonate, sodium xylenesulfonate, sodium toluenesulfonate, sodium cumenesulfonate, sodium dodecylsulfonate, sodium benzoate, sodium salicylate, sodium butyl monoglycol sulfate.

Suitable antifoams are preferably mineral oil antifoams and emulsions thereof, silicone oil antifoams and silicone oil emulsions, polyalkylene glycols, polyalkylene glycol fatty acid esters, fatty acids, polyhydric alcohols, phosphoric esters, hydrophobically modified silica, aluminium tristearate, polyethylene waxes and amide waxes.

Suitable rheology additives as agents for regulating the viscosity are, for example, starch and cellulose derivatives and hydrophobically modified ethoxylated urethanes (HEUR) thickeners, alkali-swellable acrylate thickeners, hydrophobically modified acrylate thickeners, polymers of acrylamidomethylpropanesulfonic acid, bentonite thickeners or pyrogenic silicas. Pot preservatives are added to stabilize the aqueous pigment preparations and to prevent uncontrolled multiplication of bacteria, algae and fungi. Suitable biocides are formaldehyde, formaldehyde-releasing components, methyl isothiazolinone, chloromethylisothiazolinone, benzoisothiazolinone, bronopol and dibromocyanobutane.

As buffer substances and pH regulators, preference is given to using organic or inorganic bases and acids. Preferred organic bases are amines such as ethanolamine, diethanolamine, triethanolamine, N,N-dimethylethanolamine, diisopropylamine, 2-amino-2-methyl-1-propanol and dimethylaminomethylpropanol. Preferred inorganic bases are sodium hydroxide, potassium hydroxide, lithium hydroxide and ammonia.

Pigment Preparation

The invention also provides a pigment preparation containing at least
A) a haematite pigment as described above,
B) a titanium dioxide and
water.

The above optional further constituents and preferred embodiments also apply here.

Preferred pigment preparations according to the invention contain:

from 50 to 60% of haematite pigment and titanium dioxide,

from 8 to 25% of binders,

from 0.2 to 1% of dispersants,

from 0.5 to 1% of auxiliaries and

water as balance.

In a further preferred embodiment, the haematite pigments additionally have a Newtonian flow behaviour when they are in the form of pastes, for example in the form of universal pigment pastes.

Newtonian flow behaviour is defined by a particular dependence of the viscosity of the paste on the shear rate. The viscosity is defined as a measure of the viscous flow behaviour of a fluid, for example a pigment paste, and has the unit Pa·s. The lower the viscosity, the more fluid is the flow behaviour of the fluid. The shear rate is a term in rheology, i.e. the science of deformation and flow behaviour of materials, and is defined as a measure of the mechanical loading to which a sample is subjected in a rheological measurement. Shear rate is also referred to as shear gradient. The shear rate has the unit of reciprocal time, usually l/s. In the case of fluids having ideal Newtonian flow behaviour, the viscosity is independent of the shear rate at which the viscosity is measured. The viscosity of pigment pastes is measured for the purposes of the invention by means of a cone and plate viscometer (Rheo3000 from Brookfield Engineering Laboratories, Inc., USA) at shear rates of from 500/s to 2000/s. The criterion of Newtonian flow behaviour is satisfied according to the invention when the viscosity at each measured value up to shear rates of 500/s, 1000/s, 1500/s and 2000/s differs by 10% or less, preferably by 5% or less, from the arithmetic mean of the measured values at shear rates of 500/s, 1000/s, 1500/s and 2000/s. If a measurement at a shear rate, for example when the viscosity is greater than that of the maximum measurable viscosity, the criterion of Newtonian flow behaviour is likewise not satisfied according to the invention. The measurement of the viscosity at different shear rates is, according to the invention, carried out at 20° C. The pigment paste used for the measurement is a conventional universal paste having the following composition in % by weight:

| | |
|---|---|
| PEG 200 | 10.0 |
| Water | 14.7 |
| Byk 044 | 2.0 |
| disperbyk 102 | 2.0 |
| Bentone SD 2 | 1.0 |
| disperbyk 185 | 8.8 |
| Pigment | 61.5 |

The components used here are:
PEG 200: polyethylene glycol 200, Merck KGaA, Germany
Byk 044: silicone-containing antifoam for aqueous printing inks and overprinting varnishes, from BYK Chemie GmbH, Germany
disperbyk 102: solvent-free wetting agent and dispersant from BYK Chemie GmbH, Germany
Bentone SD 2: rheological additive from Elementis Specialities, USA
disperbyk 185: solvent-free wetting agent and dispersant from BYK Chemie GmbH, Germany
The paste is produced by mixing all components with one another for 30 minutes in a high-speed mixer at 4500 rpm.

This test is referred to as paste viscosity test.

In this embodiment, the iron oxide red pigments used according to the invention have a sum of the a* values in full shade and with reduction in the surface coating test of at least 58.0 CIELAB units, preferably more than 58.5 CIELAB units, particularly preferably more than 59.0 CIELAB units, and in the paste viscosity test display Newtonian flow behaviour, with the viscosity at each measured value up to shear rates of 500/s, 1000/s, 1500/s and 2000/s differing by 10% or less, preferably by 5% or less, from the arithmetic mean of the measured values at the shear rates of 500/s, 1000/s, 1500/s and 2000/s.

In a further embodiment, the iron oxide red pigments used according to the invention have a sum of the a* values in full shade and with reduction in the surface coating test of from 58.0 to 61.0 CIELAB units, preferably from 58.0 to 60.0 CIELAB units, more preferably from 58.5 to 61.0 CIELAB units, more preferably from 58.5 to 60.0 CIELAB units, particularly preferably from 59.0 to 61.0 CIELAB units, more particularly preferably from 59.0 to 60.0, and display Newtonian flow behaviour in the paste viscosity test, with the viscosity at each measured value up to shear rates of 500/s, 1000/s, 1500/s and 2000/s differing by 10% or less, preferably by 5% or less, from the arithmetic mean of the measured values at the shear rates of 500/s, 1000/s, 1500/s and 2000/s.

In a particularly preferred embodiment, the pigments used according to the invention have a sum of the a* values in full shade and with reduction in the surface coating test of at least 58.0 CIELAB units, preferably more than 58.5 CIELAB units, particularly preferably more than 59.0 CIELAB units, and in the paste viscosity test display viscosities at shear rates of 500/s, 1000/s, 1500/s and 2000/s of from 0.300 to 0.400 Pa·s.

In a further particularly preferred embodiment, the pigments used according to the invention have a sum of the a* values in full shade and 58.0 to 61.0 CIELAB units, preferably from 58.0 to 60.0 CIELAB units, with reduction preferably from 58.5 to 61.0 CIELAB units, more preferably from 58.5 to 60.0 CIELAB units, more particularly preferably from 59.0 to 61.0 CIELAB units, more particularly preferably from 59.0 to 60.0, particularly preferably more than 59.0 CIELAB units, and in the paste viscosity test display viscosities at shear rates of 500/s, 1000/s, 1500/s and 2000/s of from 0.300 to 0.400 Pa's.

The haematite pigments used according to the invention in the form of pigment pastes also display, in a particular embodiment, Newtonian flow behaviour. This simplifies the processability of the pigments in paste and surface coating production. In addition, the haematite pigments used according to the invention can be produced by a simpler process than, for example, the Copperas pigments.

The invention also provides a process for producing the aqueous pigment preparation according to the invention, characterized in that at least
A) a haematite-pigment as defined above,
B) a titanium dioxide and
water and optionally further additives are mixed.

To produce the aqueous pigment preparations according to the invention, water is preferably used in the form of distilled or deionized water. Drinking water (mains water) and/or water of natural origin can also be used. Water is preferably present in an amount of from 10 to 65% by weight in the aqueous pigment preparation of the invention.

The aqueous pigment preparations of the invention preferably have a viscosity of from 10 to 10 000 mPas, preferably from 50 to 5000 mPas and particularly preferably from 300 to 3000 mPas, measured using a cone and plate viscometer at a shear rate of 1/60 sec⁻¹, e.g. a Haake Viscometer 550 from Thermo Haake.

The present invention also provides a process for producing the pigment preparations according to the invention by dispersing the component (A) in the form of powder or granules in the presence of water and also the remaining components in a manner which is customary per se, subsequently optionally mixing in further water and bringing the resulting aqueous pigment dispersion to the desired concentration with water. To effect dispersion, it is possible to use agitators, high-speed mixers (saw-tooth stirrers), rotor-stator mills, ball mills, stirred ball mills such as sand and bead mills, rapid mixers, kneading apparatuses, roll mills or high-performance bead mills. The fine dispersion or milling of the pigments is carried out to the desired milling fineness and can be carried out at temperatures in the range from 0 to 100° C., advantageously at a temperature in the range from 10 to 70′C, preferably at from 20 to 60° C. After fine dispersion, the pigment preparation can be diluted further with water, preferably deionized or distilled water.

Surprisingly, iron oxide red pigments which differ from conventional, known iron oxide red pigments in terms of high colour purity combined with high milling stability are obtained after milling.

### EXAMPLES AND METHODS

Titration of Iron(II) and Iron(III) Determination:

The content of iron(II) nitrate can be determined indirectly by measuring the iron(II) content by means of a potentiometric titration of an HCl-acidified sample solution with cerium(III) sulfate.

pH Measurement:

pH measurements were carried out by means of a measuring instrument from Knick, Protos MS3400-160 using Knick, MemoSens, SE533X/2-NMSN. Before the measurement, a calibration was carried out using buffer solutions of pH 4.65 and pH 9.23 (in accordance with DIN 19267). The pH measurement was carried out within the stirred reaction vessel at 85° C.

Measurement of the Chloride Content:

The determination of the chloride content is carried out by ion chromatography.

Iron Grades Used:

Iron stamping sheets having a thickness of 0.8 mm and having a manganese content of less than or equal to 2500 ppm of manganese, less than or equal to 150 mg of chromium, less than or equal to 0.07% of carbon, less than or equal to 500 ppm of aluminium, less than or equal to 400 ppm of titanium and less than or equal to 250 ppm of copper were used.

DI Water (Deionized Water):

The low-salt water used (DI water) has a conductivity of 4 μS/cm. The ion concentration can be derived from the conductivity value. The measurement was carried out by means of an electrochemical resistance measurement using an instrument from WTW. As an alternative to deionized water, it is also possible to use, for example, distilled water or purified water from a reverse osmosis plant, as long as the conductivity corresponds to the abovementioned specification.

Colour Testing:

Testing of the colour values in full shade and with reduction and also the colour intensity with reduction is carried out in a long oil alkyd resin which has been made thixotropic (in accordance with DIN EN ISO 11664-4:2011-07 and DIN EN ISO 787-25:2007). To test the colour values of inorganic colour pigments, the pigment is dispersed in a binder paste based on a non-drying long oil alkyd resin. The pigmented paste is painted into a paste plate and subsequently evaluated colorimetrically in comparison with the reference pigment.

1. Instruments Employed
Plate colour trituration machine (TFAM), plate diameter 240 mm*
Precision balance: sensitivity 0.001 g (full shade)
   sensitivity 0.0001 g (with reduction)
Spectral colour measuring instrument having the measuring geometry d/8°
Palette knife having an elastic, highly polished blade (blade length about 100 mm, width about 20 mm)
Paste plate and doctor blade based on DIN EN ISO 787-25:2007

2. Auxiliaries

2.1 Full Shade

The clear test paste (long oil alkyd resin which has been made thixotropic produced by a method based on DIN EN ISO 787-25:2007) contains 95% by weight of alkyd resin (WorléeKyd P151 from Worlée-Chemie GmbH, Germany) and 5% by weight of Luvotix HAT (Lehmann & Voss & Co. KG, Germany) as thixotrope. Here, the Luvotix is stirred into the alkyd resin which has been preheated to 70-75° C. and subsequently stirred at 95° C. until the entire thixotrope has dissolved. The cooled paste is finally rolled free of bubbles on a three-roll mill.

2.2 Reduction
White test paste (60% by weight of clear test paste+40% by weight of titanium dioxide (R-KB-2 from Sachtleben Pigment GmbH, Germany),
Petroleum spirit and cleaning cloth for cleaning the instruments (applicable to 2.1 and 2.2)

3. Procedure

3.1 Testing of the Colour Values in Full Shade

5.00 g of the clear test paste are applied to the lower part of the plate colour trituration machine (TFAM). 2.6 g of the pigment to be tested is premixed with the clear test paste on the lower plate of the colour trituration machine outside the midpoint by means of the palette knife without pressure until it is completely wetted. This mixture is subsequently dispersed by means of 3×25 revolutions. After each 25 revolutions, the material being milled is taken off from the upper plate by means of the palette knife and once again mixed with the material being milled on the lower plate and distributed outside the midpoint. The colour trituration machine is loaded with 2.5 kg of additional weight at the front bracket during the entire dispersion operation. The finished prepared paste is mixed by means of the palette knife and transferred to a paste plate until the measurement. For the purposes of the measurement, the excess paste is drawn off on the paste plate under gentle pressure by means of a paste doctor blade. After a rest time of 1 minute, the measurement of the colour values is carried out immediately.

3.2 Testing of the Colour Values with Reduction

5.00 g of the white test paste are applied to the lower part of the colour trituration machine (TFAM). 0.400 g of the pigment to be tested are weighed out, giving a mass ratio of pigment to titanium dioxide of 1:5.

The respective pigment is premixed with the binder on the lower plate of the colour trituration machine outside the midpoint by means of the palette knife without pressure until it is completely wetted. This mixture is subsequently dispersed with 5×25 revolutions. After each 25 revolutions, the material being milled is, while the motor is running, taken off from the upper plate by means of the palette knife and once again mixed with the material being milled on the lower plate and distributed outside the midpoint. The colour trituration machine is loaded with 2.5 kg of additional weight at the front bracket during the entire dispersion operation. The finished prepared paste is mixed by means of the palette knife and transferred to a paste plate until the measurement.

For the purposes of the measurement, the excess paste is drawn off on the paste plate under gentle pressure by means of a paste doctor blade. After a rest time of 1 minute, the measurement of the colour values is carried out immediately.

Other dispersing apparatuses, e.g. Mikrodismembrator S (from Sartorius) or 2-planetary centrifuge (Dual Axis Centrifugal or Vortex mixer), can be used if it is ensured by correlation tests that equivalent dispersion takes place with the settings and methods used.

4. Evaluation

The colorimetric evaluation is based on the following standards:

DIN EN ISO 116644 (2011-07). Colorimetric determination of colour numbers and colour differences in the approximately uniform CIELAB colour space

DIN 5033 Part 7 Colorimetry, measurement conditions for body colours: light type C as defined under point 2.1.1; measurement geometry d/8° as defined under point 3.2.3

EN ISO 787-25: 2007 General methods of test for pigments and extenders—Part 25: See comparison of the colour, in full-shade systems, of white, black and coloured pigments; colorimetric method (ISO 787-25:2007).

Production of the Haematite Nucleus Suspension

Nucleus Production

37 kg of iron sheet having a thickness of about 1 mm were placed in a 1 m³ reactor equipped with sieve trays (mesh opening about 10 mm), sparging ring (at the bottom of the reactor), pump circulation and inclined-blade stirrer. The sparging ring and the stirrer are installed underneath the sieve tray, the outlet of the pump circulation at the side of the iron bed, the intake of the pump circulation at the bottom of the reactor. The iron sheet was uniformly distributed over the sieve tray. 423 kg of deionized water were subsequently introduced and stirred at 120 rpm (3.2 m/s, inclined-blade stirrer, 50 cm diameter, the power input was 0.6 kW/m³ of batch volume). The support for iron was completely covered by the water. The mixture was heated to 90° C. and 97 kg of 25% strength by weight nitric acid were subsequently metered in over a period of 60 minutes. The reaction was carried out until a pH of <2.0 had been attained. This required 8 hours. The haematite nucleus suspension obtained was subsequently cooled to ambient temperature and dispensed into a container. The required amount of haematite nucleus concentrate was subsequently taken off after complete stirring-up of the nucleus in the container and used for a Penniman buildup. The haematite nucleus concentration (as Fe₂O₃) was 130 g/l.

Production of the Iron(II) Nitrate Solution

62 kg of iron sheet having a thickness of about 1 mm were placed in a 1 m³ reactor equipped with sieve trays (mesh opening about 10 mm), sparging ring (at the bottom of the reactor), pump circulation and inclined-blade stirrer. The sparging ring and the stirrer are installed underneath the sieve tray, the outlet of the pump circulation at the side of the iron bed, the intake of the pump circulation at the bottom of the reactor. The iron sheet was uniformly distributed over the sieve tray. 423 kg of deionized water were subsequently introduced and stirred at 120 rpm (3.2 m/s, inclined-blade stirrer, 50 cm diameter; the power input was 0.6 kW/m³ of batch volume). 277 kg of 25% strength by weight nitric acid were metered in over a period of 200 minutes. The reaction was carried out until a pH of 5.0 had been attained. This required 15 hours. The iron(II) nitrate solution obtained was subsequently cooled to ambient temperature and dispensed into a container. After a sedimentation time of 24 hours, the upper phase (clear phase) was separated off from the yellow/brown sediment and subsequently used in a Penniman buildup. The iron(II) nitrate concentration was 120 g/l.

### Example 1

55 kg of iron sheet having a thickness of about 1 mm were placed in a 1 m³ reactor equipped with sieve trays (mesh opening about 10 mm), sparging ring (at the bottom of the reactor), pump circulation and inclined-blade stirrer. The sparging ring and the stirrer are installed underneath the sieve tray, the outlet of the pump circulation at the side of the iron bed, the intake of the pump circulation at the bottom of the reactor. The iron sheet was uniformly distributed over the sieve tray. Deionized water and iron(II) nitrate are subsequently introduced in such an amount that a volume of 510 litres was attained and the concentration of iron(II) nitrate (calculated as anhydrous iron nitrate) was 62 g/l. The mixture was mixed during the entire reaction time by means of a stirrer (80 rpm, 2.1 m/s, inclined-blade stirrer, 50 cm diameter, the power input was 0.31 kW/m³ of batch volume). 1 hour after addition of the iron(II) nitrate solution, 161 litres of haematite nucleus suspension having a concentration of 130 g/I (based on Fe₂O₃) were added and the mixture was heated to 85° C. After 1 hour at 85° C., sparging with 800 l/h of air was commenced. In addition, 2 m³/h of nitrogen were introduced if necessary via a sparging ring in order to keep the reaction pH in the range of 2.2-2.4 (switching-in of nitrogen sparging at pH values of 2.2 and shutting off again at pH 2.4).

During the reaction, 1 litre suspension samples were taken at intervals of 4 h and these were filtered on a suction filter and washed with deionized water. The washing operation was continued until the filtrate had a conductivity of <1000 μS/cm. The filter cake was subsequently dried at 80° C. to a residual moisture content of less than 5% by weight and the colour was determined in the surface coating system (for a precise description of the colour test, see methods). After the desired colour space had been attained, the reaction mixture was admixed with iron(II) sulfate (29 litres containing 206 g/l of FeSO₄) and subsequently filtered via a filter press and the haematite pigment obtained was washed with deionized water until the conductivity of the filtrate was <1000 μS/cm. The haematite pigment is subsequently dried at 80° C. to a residual moisture content of less than 5% by weight. The dried filter cake is subsequently comminuted mechanically by means of a shredder. The haematite pigment was thus obtained in powder form in a yield of 81.0 kg. The total reaction time was 185 hours. The colour test was carried out according to the above-described method description. The chloride content of the dried pigment was found to be 0.006% by weight. The viscosities in the paste viscosity test were: 0.358 Pa·s (at 500/s), 0.341 Pa·s (at 1000/s), 0.337 Pa·s (at 1500/s) and 0.344 Pa·s (at 2000/s).

### Example 2 (Comparative Example)

55 kg of iron sheet having a thickness of about 1 mm were placed in a 1 m³ reactor equipped with sieve trays (mesh opening about 10 mm), sparging ring (at the bottom of the reactor), pump circulation and inclined-blade stirrer. The sparging ring and the stirrer are installed underneath the sieve tray, the outlet of the pump circulation at the side of the iron bed, the intake of the pump circulation at the bottom of the reactor. The iron sheet is uniformly distributed over the sieve tray. Deionized water and iron(II) nitrate are subsequently introduced in such an amount that a volume of 510 litres was attained and the concentration of iron(II) nitrate (calculated as anhydrous iron nitrate) was 62 g/l. The mixture was mixed during the entire reaction time by means of a stirrer (80 rpm, 2.1 m/s, inclined-blade stirrer, 50 cm diameter; the power input was 0.31 kW/m³ of batch volume). 1 hour after addition of the iron(II) nitrate solution, 161 litres of haematite nucleus suspension having a concentration of 130 g/l (based on Fe₂O₃) were added and the mixture was heated to 85° C. After 1 hour at 85° C., sparging with 800 l/h of air was commenced. The pH in the reaction is shown in FIG. 1. During the reaction, 1 litre suspension samples were taken at intervals of 4 h and these were filtered on a suction filter and washed with deionized water. The washing operation was continued until the filtrate had a conductivity of <1000 μS/cm. The filter cake was subsequently dried at 80° C. to a residual moisture content of less than 5% by weight and the colour was determined in the surface coating system (for a precise description of the colour test, see methods). After the desired colour space had been attained, the reaction mixture was admixed with iron(II) sulfate (29 litres containing 206 g/l of FeSO₄) and subsequently filtered via a filter press and the haematite pigment obtained was washed with deionized water until the conductivity of the filtrate was <1000 μS/cm. The haematite pigment is subsequently dried at 80° C. to a residual moisture content of less than 5% by weight. The dried filter cake is subsequently comminuted mechanically by means of a shredder. The haematite pigment was thus obtained in powder form in a yield of 76.0 kg. The total reaction time was 96 hours. In the surface coating test, an a* value in full shade of 29.5 CIELAB units and with reduction an a* of 25.1 CIELAB units were measured. The sum of the a* values is accordingly 54.6 CIELAB units. The surface coating test was carried out according to the above-described method description.

TABLE 2
Colour values of the examples in the surface coating test

| | | | | | | | Sum of |
|---|---|---|---|---|---|---|---|
| | | | | | | | a* in |
| | | | | | | | full |
| | a* | b* | C* | a* | b* | C* | shade + |
| | full | full | full | with re- | with re- | with re- | a* with |
| Example | shade | shade | shade | duction | duction | duction | reduction |
| 1 | 31.0 | 25.0 | 39.8 | 28.7 | 20.8 | 35.4 | 59.7 |
| 2 (for | 29.5 | 22.2 | 36.9 | 25.1 | 15.2 | 9.3 | 54.6 |
| com- | | | | | | | |
| parison) | | | | | | | |

TABLE 3
Comparative values based on the internal reference
standard of a pigment of the type R1599D

| | | | | | | | Sum of |
|---|---|---|---|---|---|---|---|
| | | | | | | | Δa* in |
| | | | | | | | full |
| | Δa* | Δb* | ΔC* | Δa* | Δb* | ΔC* | shade + |
| | full | full | full | with re- | with re- | with re- | Δa* with |
| Example | shade | shade | shade | duction | duction | duction | reduction |
| 1 | 0.5 | 0.2 | 0.5 | 1.5 | 2.0 | 2.3 | 2.0 |
| 2 (for | −1.0 | −2.6 | −2.4 | −2.1 | −3.6 | −3.8 | −3.1 |
| com- | | | | | | | |
| parison) | | | | | | | |

In a preferred embodiment, the iron oxide red pigments used according to the invention additionally have increased milling stability when they are produced in the form of aqueous pigment concentrates with subsequent conversion into a surface coating composition using an aqueous acrylate dispersion.

### Examples

Description of the Measurement Methods Used

The tests on milling stabilities were carried out by way of example in a 3-stage system consisting of a pigment concentrate containing the pigment from Example 1, a surface coating binder and a white surface coating for reduction.

For the colorimetric evaluation, the pigment concentrates were firstly produced with different degrees of dispersion; firstly by means of a high-speed mixer Dispermat FM 10 SIP from Getzmann for 10 minutes, secondly by means of the paint mixer RM 500 from Olbrich know how, D-58675 Hemer using glass beads having a diameter of 3 mm for 30 minutes. The pigment concentrates were subsequently converted into a surface coating composition in an aqueous acrylate binder. To examine the reduction, the pigment concentrates with surface coating binder produced in this way were subsequently mixed with a white concentrate and stored for 24 hours. The surface coating with reduction was subsequently applied in a layer thickness of 200 μm to white paperboard. After 24 hours, the colour measurement was carried out on a Datacolor SF 600 spectral colour measuring instrument. The colour differences were determined by a method based on DIN EN ISO 11664-4 (2011-07) and DIN 5033 Part 7.

The milling stability is determined from the total colour difference dEab* determined on the surface coating with reduction produced after high-speed dispersion for 10 minutes by means of the Dispermat FM 10 SIP as reference and the surface coating with reduction using the paint mixer RM 500 after 30 minutes as sample.

Production of the Pigment Concentrates

The aqueous pigment concentrate containing the pigment from Example 1 was produced with a pigment concentration of 67%. For dispersion, the pigment preparation was placed in a suitable vessel suitable for the size of the batch and homogenized in a manner known to those skilled in the art. After addition of the pigment, the pH is set to 8.5+/−0.2 by addition of sodium hydroxide solution, 10% strength, in a manner known to those skilled in the art.

The pigment concentrate used for the measurement has the following composition in % by weight:

| | |
|---|---|
| Distilled water | 25.4 |
| Dispex Ultra PX 4575 | 6.7 |
| Lucrafoam DNE 01 | 0.5 |
| Deuteron VT 819 | 0.2 |
| Preventol D7 | 0.2 |
| Pigment from Example | 167.0 |

The components used here are:
Dispex Ultra PX 4575: acrylate-based block copolymer from BASF SE Formulation Additives, Germany
Lucrafoam DNE 01: mineral oil antifoam from LEVACO Chemicals GmbH, Germany
Deuteron VT 819: anionic heteropolysaccharide (xanthan gum) from Deuteron GmbH, Germany
Preventol D7: formulation containing isothiazolinones, LANXESS Deutschland GmbH

Surface Coating Composition Binder

The aqueous acrylate dispersion Alberdingk® AC 2025 from Alberdingk Boley GmbH, Germany, was used as binder for producing the surface coating composition.

Production of the White Paste for Reduction

The white titanium dioxide paste for reduction was produced with a pigment concentration of 70%. For dispersion, the pigment preparation was placed in a suitable vessel suitable for the size of the batch and homogenized in a manner known to those skilled in the art. After addition of the pigment, the pH is set to 8.5+/−0.2 by addition of sodium hydroxide solution, 10% strength, in a manner known to those skilled in the art and dispersed at 3000 rpm in the high speed mixer Dispermat FM 10 SIP from Getzmann for 15 minutes.

The white paste used for the measurement has the following composition in % by weight:

| | |
|---|---|
| Distilled water | 22.4 |
| Dispex Ultra PX 4575 | 5.3 |
| Lucrafoam DNE 01 | 0.5 |
| Deuteron VT 819 | 0.1 |
| Preventol D7 | 0.2 |
| Sachtleben R-KB-2 | 70.0 |

The components used here are:
Dispex Ultra PX 4575: acrylate-based block copolymer from BASF SE Formulation Additives, Germany
Lucrafoam DNE 01: mineral oil antifoam from LEVACO Chemicals GmbH, Germany
Deuteron VT 819: anionic heteropolysaccharide (xanthan gum) from Deuteron GmbH, Germany
Preventol D7: formulation containing isothiazolinones, LANXESS Deutschland GmbH
Sachtleben R-KB-2: micronized titanium dioxide (rutile) from Sachtleben Pigment GmbH, Germany

The pigment concentrates produced in this way, the surface coating binder and the white paste for reduction were mixed in the following ratios and homogenized for 20 minutes in the FAS 500 paint mixing instrument from Lau.

Pigment from Example 1: Sachtleben R-KB-2 Ratio 1:1

2.55 g of pigment concentrate+15 g of surface coating binder+2.44 g of white paste

Pigment from Example 1: Sachtleben R-KB-2 ratio 1:5

0.86 g of pigment concentrate+15 g of surface coating binder+4.14 g of white paste

Pigment from Example 1: Sachtleben R-KB-2 ratio 1:10

0.47 g of pigment concentrate+15 g of surface coating binder+4.53 g of white paste

Evaluation

The colorimetric evaluation is based on the following standards:

DIN EN ISO 11664-4 (2011-07). Colorimetric determination of colour numbers and colour differences in the approximately uniform CIELAB colour space

DIN 5033 Part 7 Colorimetry, measurement conditions for body colours; light type C as defined under point 2.1.1; measurement geometry d/8° as defined under point 3.2.3

EN ISO 787-25: 2007 General methods of test for pigments and extenders—Part 25: Comparison of the colour, in full-shade systems, of white, black and coloured pigments; colorimetric method (ISO 787-25:2007).

The total colour difference dEab* in the surface coating test with reduction using different haematite pigment from Example 1: titanium dioxide ratios is shown in Table 2 below.

TABLE 2
Total colour differences in the surface coating test with
reduction using different titanium dioxide ratios

| | Pigment from Example 1: | | |
|---|---|---|---|
| | Sachtleben R-KB-2 | | |
| | 1:1 | 1:5 | 1:10 |
| | dEab* | | |
| Pigment from Example 1 | ≤0.3 | ≤0.6 | ≤0.6 |
| Laux pigment | ≤0.5 | ≤0.7 | ≤1.7 |

The iron oxide red pigments used according to the invention have a total colour difference dEab* at a ratio of pigment from Example 1 to Sachtleben R-KB-2 1:1 of ≤0.3, at a ratio of 1:5 of dEab* of ≤0.6 and at a ratio of 1:10 of dEab* of ≤0.6.

Preference is given to a total colour difference dEab* for a pigment TiO₂ ratio of 1:1 of less than 0.4.

1. A method for producing an aqueous, pigmented, titanium dioxide-containing preparation, the method comprising combining:
a haematite pigment whose sum of the a* values in full shade and with reduction in the surface coating test is 58.0 to 61.0 CIELAB units,
titanium dioxide, and
water
to produce an aqueous, pigmented, titanium dioxide-containing preparation.

2. The method according to claim 1, wherein the haematite pigment has the modification α-Fe₂O₃.

3. The method according to claim 1, wherein the haematite pigment has a particle size of 0.1 to 0.3 μm.

4. The method according to claim 3, wherein at least 80% by weight of the haematite pigment has the particle size of 0.1 to 0.3 μm.

5. The method according to claim 1, wherein the haematite pigment has a Newtonian flow behaviour in the paste viscosity test, with the viscosity at each measured value at shear rates of 500/s, 1000/s, 1500/s and 2000/s differing by 10% or less, preferably by 5% or less, from the arithmetic mean of the measured values at the shear rates of 500/s, 1000/s, 1500/s and 2000/s.

6. The method according to claim 1, further comprising producing the haematite pigment by contacting:
iron,
haematite nucleus suspension containing haematite nuclei having a particle size of 100 nm or less and a specific BET surface area of 40 m²/g to 150 m²/g (measured in accordance with DIN 68131), and
iron(II) nitrate solution
in the presence of at least one oxygen-containing gas at temperatures of 70 to 99° C. wherein the contacting takes place at a pH of 2.2 to pH 4.0, preferably from pH 2.2 to pH 3.0, producing a haematite pigment suspension.

7. The method according to claim 1, wherein the titanium dioxide is of rutile type.

8. The method according to claim 1, wherein the aqueous, pigmented, titanium dioxide-containing preparation comprises:
50 to 60% of the haematite pigment and titanium dioxide,
8 to 25% of binders,
0.2 to 1% of dispersants,
0.5 to 1% of auxiliaries and
water as balance.

9. The method according to claim 1, wherein the aqueous, pigmented, titanium dioxide-containing preparation comprises at least one organic binder.

10. The method according to claim 1, wherein:
the haematite pigment:
has the modification α-Fe₂O₃,
has a Newtonian flow behaviour in the paste viscosity test, with the viscosity at each measured value at shear rates of 500/s, 1000/s, 1500/s and 2000/s differing by 10% or less, preferably by 5% or less, from the arithmetic mean of the measured values at the shear rates of 500/s, 1000/s, 1500/s and 2000/s, and
at least 80% by weight of the haematite pigment has a particle size of 0.1 to 0.3 μm;
the titanium dioxide is of rutile type; and
the combining further comprises adding organ binders.

11. A pigment preparation comprising:
A) haematite pigment whose sum of the a* values in full shade and with reduction in the surface coating test is 58.0 to 61.0 CIELAB units,
B) titanium dioxide, and
water.

12. The pigment preparation according to claim 11, further comprising at least one organic binder.

13. The pigment preparation according to claim 11, wherein the sum of the a* values is 58.0 to 60.0 CIELAB units.

14. The pigment preparation according to claim 11, wherein the sum of the a* values is 58.5 to 60.0 CIELAB units

15. The pigment preparation according to claim 11, wherein:
the sum of the a* values is 59.0 to 60.0 CIELAB units;
the haematite pigment:
has the modification α-Fe₂O₃,
has a Newtonian flow behaviour in the paste viscosity test, with the viscosity at each measured value at shear rates of 500/s, 1000/s, 1500/s and 2000/s differing by 10% or less, preferably by 5% or less, from the arithmetic mean of the measured values at the shear rates of 500/s, 1000/8, 1500/s and 2000/s, and
at least 80% by weight of the haematite pigment has a particle size of 0.1 to 0.3 μm; and
the titanium dioxide is of rutile type.

16. The method according to claim 1, wherein the sum of the a* values is 58.0 to 60.0 CIELAB units.

17. The method according to claim 1, wherein the sum of the a* values is 58.5 to 60.0 CIELAB units.

18. The method according to claim 1, wherein the sum of the a* values is 59.0 to 60.0 CIELAB units.

19. The method according to claim 10, wherein the sum of the a* values is 59.0 to 60.0 CIELAB units.
